(19) United States
(12) Patent Application Publication
(10) Pub. No.: US 2005/0280265 A1
(43) Pub. Date: Dec. 22, 2005

(54) Locking device for locking a closure panel

(76) Inventors: Vlad Iliescu, Southfield, MI (US); Scott Davis, Clinton Twp, MI (US); Vasanth Suratkal, Bloomfield, MI (US); Daniel Udriste, Weston, FL (US)

Correspondence Address: PILLSBURY WINTHROP SHAW PITTMAN LLP, 1650 TYSONS BOULEVARD, MCLEAN, VA, 22102, US

(21) Appl. No.: 11/119,759

(22) Filed: May 3, 2005

Related U.S. Application Data
(60) Provisional application No. 60/567,457, filed on May 4, 2004.

(51) Int. Cl. E05C 3/06

(52) U.S. Cl. 292/216

(57) ABSTRACT

The invention relates to a locking device for locking a closure panel to a body of a vehicle. The locking device comprises a catch, a pawl and a release actuator, each of which being moveable between a locked position and an unlocked position. The locking device is in a locked state when the catch, the pawl and the release actuator are in their locked positions, and the locking device is in an intermediate unlocked state when the catch is in its locked position and the pawl and the release actuator are in their unlocked positions. The locking device further comprises coupling means which is arranged such that it couples the release actuator to the pawl when the locking device is in the locked or intermediate unlocked state and uncouples the release actuator from the pawl when, starting from the intermediate unlocked state, the catch has moved to its unlocked position.

This application claims the benefit of U.S. Provisional Application No. 60/567,457, filed May 4, 2004, which is herein incorporated by reference in its entirety.

### BACKGROUND

1. Field of the Invention

The invention relates to a locking device for locking a closure panel, in particular a decklid, door, rear flip glass or hood of a vehicle.

2. Background of the Invention

A locking device for locking a closure panel, like a decklid, door, rear flip glass or hood of a vehicle, comprises typically a locking striker secured to one of the closure panel and the body of the vehicle and a catch with a hook part rotatably secured to the other of the closure panel and the body. For locking the closure panel the catch can be rotated to a locked position in which the hook part is in hook engagement with the locking striker. For unlocking the closure panel the catch can be rotated to a unlocked position in which the hook part is in disengagement with the locking striker.

In general the catch is retained in its locked position by a pivoted pawl wherein a retaining shoulder of the pawl is in engagement with a corresponding detent portion of the catch. The catch is coupled to a catch spring which is biased when the catch is in its locked position, and the pawl is coupled to a release actuator. The release actuator comprises a linearly moveable shaft wherein one end portion of the shaft abuts against a corresponding portion of the pawl. For unlocking the closure panel the shaft is moved towards the pawl thereby rotating the pawl such that the retaining shoulder of the pawl disengages the catch to allow the catch to move in the unlocked position.

For locking the closure panel the pawl has to be positioned in a locked position, in which the pawl can engage the catch, when the catch is rotated back to its locked position by the locking striker.

Under certain conditions, e.g. an inside or outside load that prevents the closure panel from opening, the urging force of the catch spring might not be large enough to rotate the catch. In such a case, the pawl should not be positioned in its locked position to allow a manual opening of the closure panel. Therefore, a locking device with a release memory function would be desirable which positions the pawl in its locked position only if during the foregoing unlocking procedure the catch has been rotated.

### BRIEF SUMMARY OF THE INVENTION

It is, therefore, the object of the present invention to provide a locking device with a release memory function which positions the pawl in its locked position only if during the foregoing unlocking procedure the catch has been rotated.

Another object of the present invention is to provide a locking device which facilitates locking of the closure panel in case of failure of an electric release actuator in an unlocked state.

Another object of the present invention is to provide a locking device which allows for easy manual unlocking in case of failure of an electric release actuator in a locked state.

The locking device for locking a closure panel, in particular a decklid, door, rear flip glass or hood of a vehicle, to a body of the vehicle, comprises, according to the present invention, a catch rotatable between a locked position in which the closure panel is locked and an unlocked position in which the closure panel is unlocked wherein the catch is spring biased towards its unlocked position. The locking device further comprises a pawl rotatable between a locked position, in which the pawl holds or is ready to hold the catch in its locked position, and an unlocked position, in which the catch is free to rotate to its unlocked position, wherein the pawl has a retaining portion which is engagable with a corresponding detent portion of the catch and wherein the pawl is spring biased towards its locked position. The locking device also comprises a release actuator for moving the pawl to its unlocked position wherein the release actuator is movable between a locked position and an unlocked position. The locking device is in a locked state when the catch, the pawl and the release actuator are in their locked positions. The locking device is in an intermediate unlocked state when the catch is in its locked position and the pawl and the release actuator are in their unlocked positions. The release actuator is selectively coupled to or uncoupled from the pawl by coupling means. The coupling means is arranged such that it couples the release actuator to the pawl when the locking device is in the locked or intermediate unlocked state, and uncouples the release actuator from the pawl when, starting from the intermediate unlocked state, the catch has moved to its unlocked position, whereby the pawl is released to its locked position and the locking device is ready for being locked.

The coupling means can comprise a rotatable coupling lever which is coupled to the release actuator.

The coupling lever and the pawl preferentially are rotatable around a common rotational axis.

It is further preferred that the locking device further comprises a coupling lever spring, in particular a torsion spring, connected to the coupling lever for providing a spring force biasing the coupling lever towards the release actuator.

The release actuator can comprise a linearly movable release element wherein an end portion of which abuts against a protrusion of the coupling lever for rotating the coupling lever.

The release element can be a linearly moveable rack.

Preferentially, the coupling lever comprises a coupling opening having a slot like securing portion defined by side edges substantially extending in radial directions with regard to the rotational axis, and a slot like freewheeling portion defined by side edges substantially extending in a circumferential direction with regard to the rotational axis, wherein the securing portion extends between first and second radial positions and wherein the freewheeling portion extends between first and second circumferential positions. The pawl can comprise a slot extending in a radial direction with regard to the common rotational axis wherein the slot extends between the first and the second radial positions. A coupling pin can be inserted in the slot and in the coupling opening of the coupling lever, wherein the pawl is securely coupled to the coupling lever, when the coupling pin is positioned in the securing portion of the coupling opening, and wherein the pawl is freely moveable within the first and second circumferential positions relative to the coupling lever, when the coupling pin is positioned in the freewheeling portion of the coupling opening. The coupling means can further comprise a rotatable transfer lever for transferring the coupling pin from the securing portion of the coupling opening to the freewheeling portion of the coupling opening and vice versa.

In a preferred embodiment the coupling opening is substantially L-shaped.

The transfer lever comprises preferentially an arcuate slot-like transfer opening, wherein the transfer lever is rotatable between a freewheeling position and a securing position. In the freewheeling position the transfer opening extends in a circumferential direction with regard to the common rotational axis of the coupling lever and the pawl, and is in register with the freewheeling portion of the coupling opening such that the coupling pin is freely moveable within the freewheeling portion and the transfer opening. In the securing position an end portion of the transfer opening is positioned at a radial position corresponding to a bottom portion of the securing portion of the coupling opening and a bottom portion of the slot of the pawl such that the coupling pin is held in the bottom portions of the securing portion and of the slot, respectively.

The catch can comprise a protrusion which is arranged such that, when the catch rotates from its unlocked position to its locked position, the protrusion abuts against and moves along an edge of the transfer lever, thereby rotating the transfer lever from its securing position to its freewheeling position and transferring the coupling pin of the pawl from the bottom portion of the securing portion of the coupling opening to the freewheeling portion thereof.

The transfer lever is preferentially positioned between the pawl and the coupling lever.

The locking device can further comprise a transfer lever spring, in particular a torsion spring, for providing a spring force biasing the transfer lever so as to move the coupling pin into the securing portion of the coupling opening of the coupling lever.

In a preferred embodiment the catch, the pawl and the coupling means are mounted in a housing wherein the pawl comprises an extension which protrudes outside the housing to allow for manually rotating the pawl to its unlocked position.

The coupling means can be arranged such that, during rotation of the catch from its locked position to its unlocked position, the pawl remains coupled to the release actuator, as long as the detent portion of the catch has not passed the retaining portion of the pawl, and is uncoupled from the release actuator, after the detent portion of the catch has passed the retaining portion of the pawl.

In a preferred embodiment the catch comprises several successive detent portions each corresponding to the retaining portion of the pawl to hold the catch in successive locked positions and wherein the coupling means is arranged such that, during rotation of the catch from one of its locked positions to its unlocked position, the pawl remains securely coupled to the release actuator, as long as not all of the detent portions have passed the retaining portion of the pawl, and is uncoupled from the release actuator, after all of the detent portions of the catch have passed the retaining portion of the pawl.

Furthermore, the present invention comprises a vehicle having a closure panel, in particular a decklid, door, rear flip glass or hood, pivoted to a body of the vehicle for closing an opening of the body comprising a locking device according to the present invention attached to one of the closure panel and the body and a locking striker attached to the other of the closure panel and the body, wherein the catch of the locking device is in engagement with the locking striker when the locking device is in its locked position and wherein the catch is in disengagement with the locking striker when the locking device is in its unlocked position.

### BRIEF DESCRIPTION OF THE DRAWINGS

FIG. 1 is a schematic back view of a vehicle comprising a closure panel and a locking device according to the invention.

FIG. 2 is a schematic view showing a locking striker and a catch of the locking device of FIG. 1 in a locked position.

FIG. 3 is a schematic view showing the locking striker and the catch of FIG. 2 in an unlocked position.

FIG. 4 is a perspective view of the locking device in a first direction, FIG. 5 is a perspective view of the locking device in a second direction, FIG. 6 is a perspective view of the locking device in a third direction,

FIG. 7 is a plan view of a pawl, a transfer lever and a coupling lever of the locking device wherein the pawl is securely coupled to the coupling lever,

FIG. 8 is a plan view of the pawl, the transfer lever, the coupling lever and the catch of the locking device wherein the pawl is freewheelingly coupled to the coupling lever,

FIGS. 9 to 13 are plan views of the locking device showing an unlocking procedure.

### DETAILED DESCRIPTION OF THE INVENTION

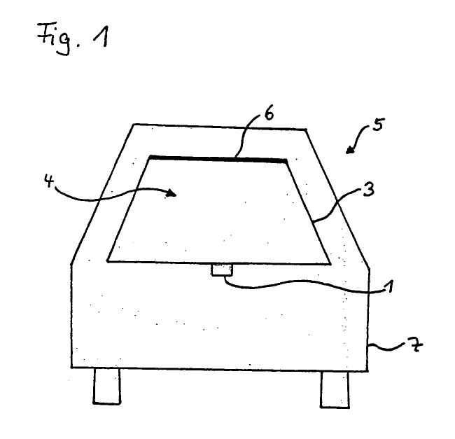

FIG. 1 schematically shows a backside of a vehicle 5 with a decklid 3 (closure panel), which closes an opening 4 of a body 7 of the vehicle 5. The decklid 3 is pivoted to the body 7 at a horizontal pivot axis 6 such that the decklid 3 can be opened in an upward direction to allow access e.g. to a vehicle cargo area. The vehicle 5 comprises a locking device 1 for locking the decklid 3 to the body 7.

As an alternative to FIG. 1, the locking device I may lock a rear flip glass, hood or door of the vehicle to the body of the vehicle. Generally speaking, the locking device of this invention can be used to lock any closure panel to any kind of opening.

Generally, the locking device 1 is attached to the body of the vehicle, and a locking striker is attached to the decklid. Alternatively, the locking device could be attached to the decklid and the locking striker could be attached to the body of the vehicle.

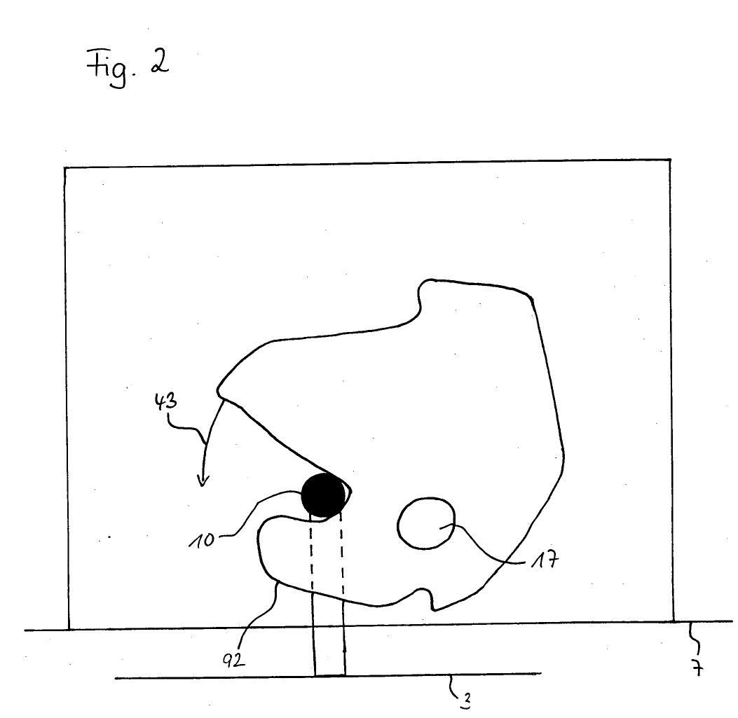

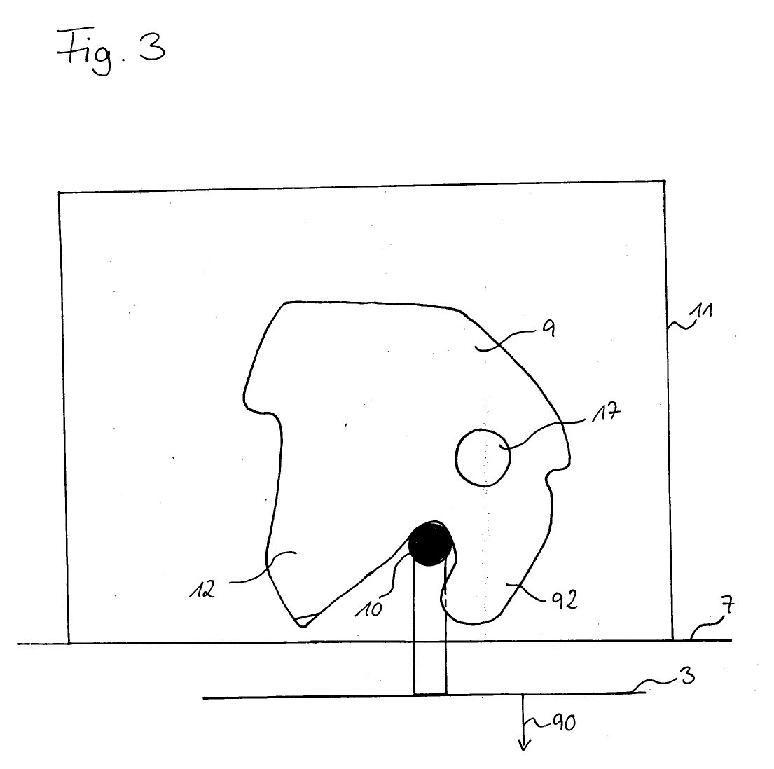

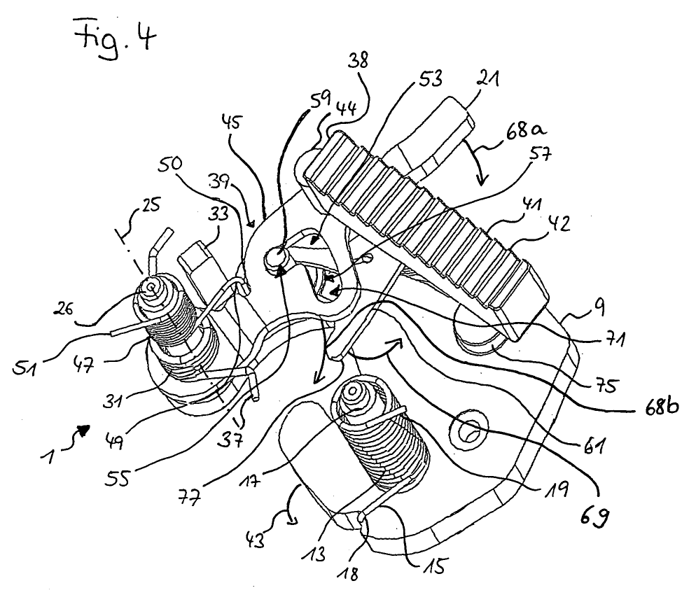

As schematically illustrated in FIGS. 2 and 3, the locking device I comprises a catch 9 pivoted to a base frame 11 which is fixed to the body 7 of the vehicle. The catch 9 is pivoted to the base frame 11 by a catch pivot bar 17. In a locked position (FIG. 2), a hook part 92 of the catch 9 engages a locking striker 10 fixed at the decklid 3 thereby locking the decklid 3 to the body 7. For unlocking the decklid 3, the catch is rotated in a release direction 43 towards an unlocked position (FIG. 3), where the locking striker 10 is released from and in disengagement with the hook part 92 of the catch 9.

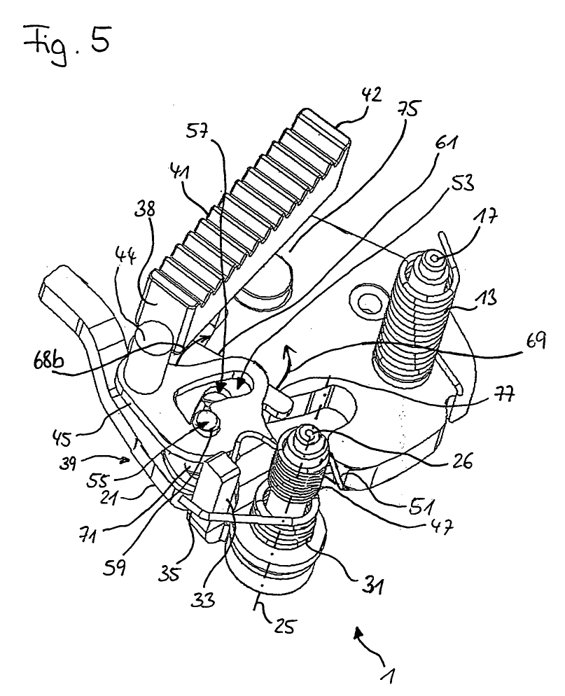

As shown in more detail in FIGS. 4 to 6, a catch spring is 13 coiled around the catch pivot bar 17. One end portion 15 of the catch spring 13 engages a recess 18 of the catch 9, and an opposite end portion 19 of the catch spring 9 is attached to the base frame 11 (not shown) thereby providing a rotational force acting in release direction 43.

The locking device 1 further comprises a pawl 21 which is rotatably supported for movement around a rotational axis 25 by a pawl pivot bar 26. The pawl 21 has a retaining portion 27 (FIG. 6), which is engagable with a corresponding detent portion 29 of the catch 9 to hold the catch 9 in its locked position. Pawl pivot bar 26 and catch pivot bar 27 are supported by the base frame 11. A pawl spring 31 is coiled around the pawl pivot bar 26, wherein one end portion 35 of the pawl spring 31 acts against a protrusion 33 of the pawl 21 and an opposite end portion 37 of the pawl spring 31 is coupled to the base frame 11 thereby providing a spring force acting in direction 68a which biases or tends to rotate the pawl 21 towards the catch 9.

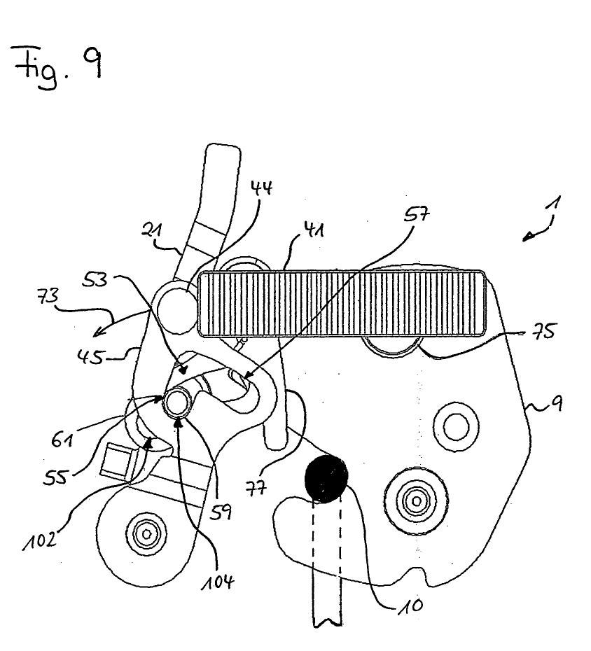

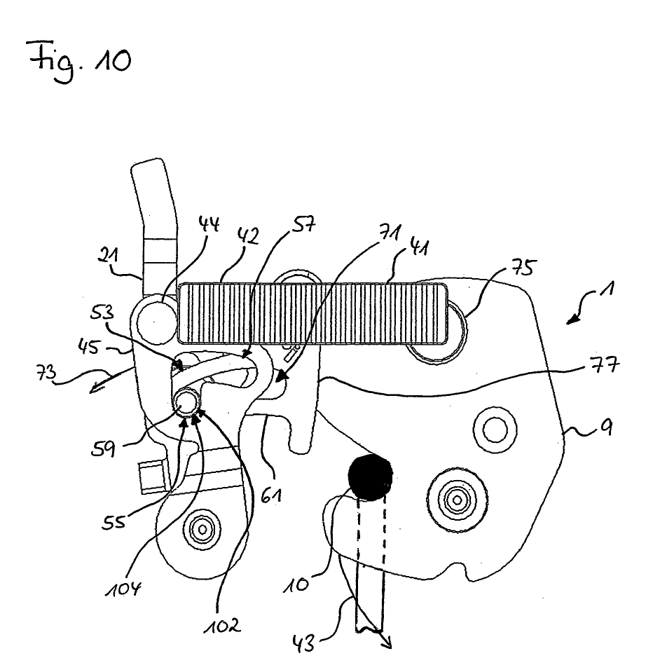

The locking device 1 further includes a coupling means 39 which selectively couples the pawl 21 to or uncouples it from a release actuator, as described in more detail below. The release actuator comprises a rack 41 actuated by a motor unit coupled to a gear wheel (both not shown) which engages the rack 41 for movement towards the coupling means 39 to an unlocked position (FIG. 9) and in a reverse direction to a locked position (FIG. 10-13).

An end portion 38 of the rack 41 abuts against a protrusion 44 of a coupling lever 45 of the coupling means 39. The coupling lever 45 is rotatably supported by the pawl pivot bar 26. Thus, both of the pawl 21 and the coupling lever 45 are rotatable around rotational axis 25. A coupling lever spring 47 is coiled around the pawl pivot bar 26 wherein one end portion 49 of the coupling lever spring 47 engages a recess 50 of the coupling lever 45 and an opposite end portion 51 of the coupling lever spring 47 is coupled to the base frame 11 thereby providing a rotational force acting in direction 68b which biases or tends to rotate the coupling lever 45 towards the catch 9.

The coupling lever 45 comprises a substantially L-shaped coupling opening 53 having a securing portion 55 and a freewheeling portion 57. The securing portion 55 of the coupling opening 53 is configured as a slot defined by side edges that substantially extend in radial directions with regard to rotational axis 25. The freewheeling portion 57 of the coupling opening 53 is configured as a slot defined by side edges substantially extending in a circumferential direction with regard to rotational axis 25.

A coupling pin 59 is inserted in the coupling opening 53 and in a corresponding radially extending slot 100 provided in the pawl 21 (FIG. 6). Thus, the pawl 21 is securely coupled to the coupling lever 45, when the coupling pin 59 is positioned in the securing portion 55 of the coupling opening hole 53. On the other hand the pawl 21 is freely moveable relative to the coupling lever within the circumferential extension of the freewheeling portion 57, when the coupling pin 59 is positioned in the freewheeling portion 57 of the coupling opening 53.

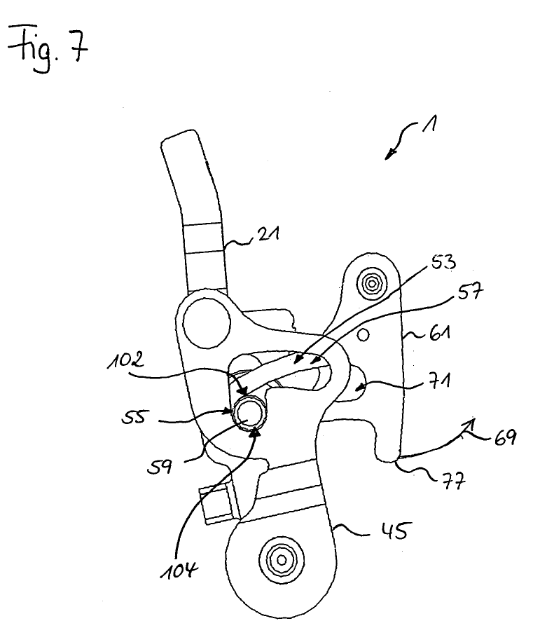

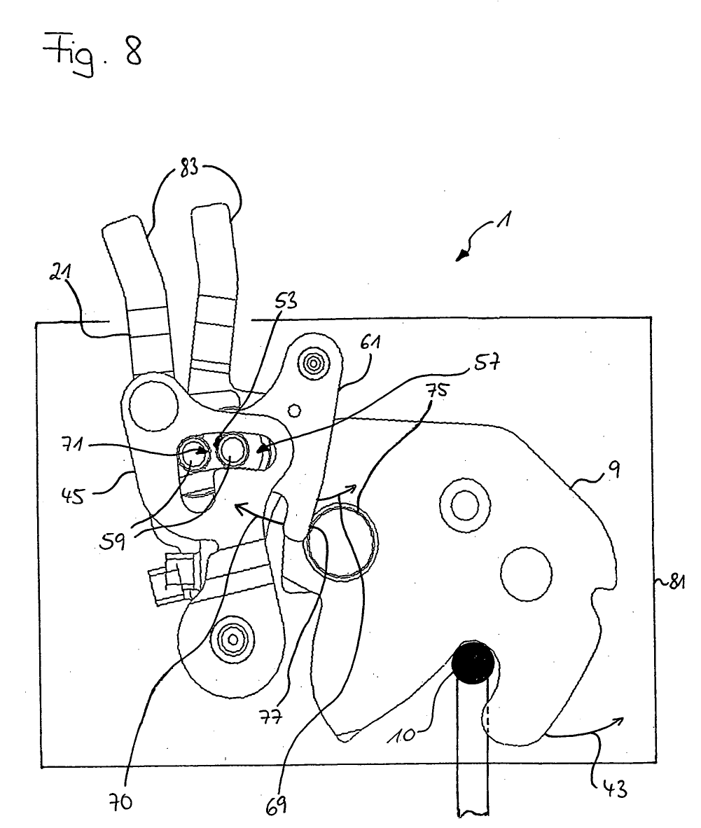

For transferring the coupling pin 59 from the securing portion 55 of the coupling opening 53 to the freewheeling portion 57 and vice versa, the locking device I comprises a transfer lever 61. In the example shown, the transfer lever 61 is placed between the pawl 21 and the coupling lever 45. The transfer lever 61 is rotatably supported by a transfer lever pivot bar 63 providing a rotational axis 64. The pivot bar 63 is coupled to the base frame 11. An arcuate slot like transfer opening 71 is provided as to extend in a circumferential direction with regard to axis 25 when the transfer lever 61 is in a freewheeling position shown in FIG. 8. In the freewheeling position of the transfer lever 61, the coupling pin 59 is floatingly guided by the radial slot 100 of the pawl, the transfer opening 71 and the freewheeling portion 57 of the coupling opening 53.

A transfer lever spring 65 is coiled around the transfer lever pivot bar 63 wherein one end portion of the transfer lever spring 65 is connected to the transfer lever 61 and an opposite end portion 67 is connected to the base frame 11 thereby providing a rotational force acting in and biasing or tending to rotate the transfer lever 61 in direction 69 (FIG. 8). Thus, the transfer lever moves or holds coupling pin 59 in the securing portion 55 of the coupling opening 53 when the relative circumferential or rotational position of the pawl and the coupling lever is such that the radial slot 100 of the pawl is in register with the securing portion 55.

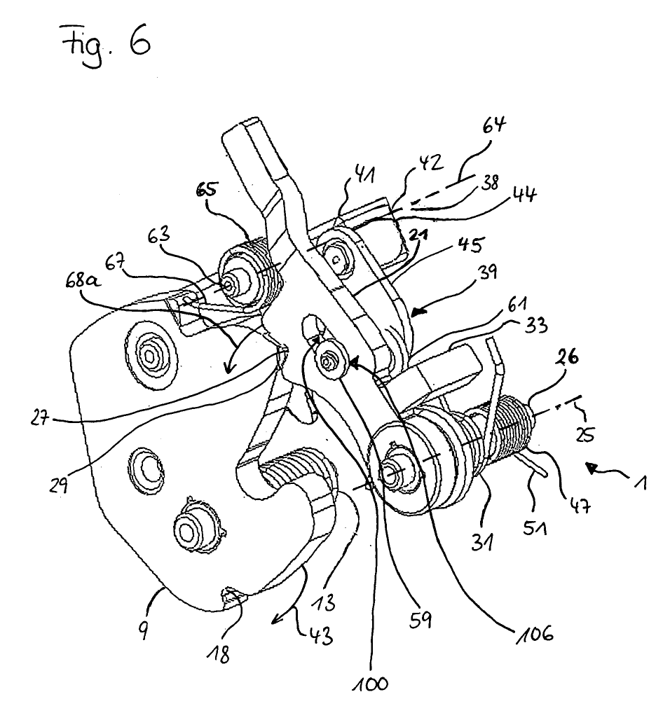

The transfer lever 61 is rotatable between the above mentioned freewheeling position in which the transfer opening 71 is in register with the freewheeling portion 57 of the coupling opening 53 (sec FIG. 8, in which two different positions of the pawl 21 and the coupling pin 59 are shown) and a securing position in which an end portion 102 of the transfer opening 71 is positioned at a radial position corresponding to a bottom portion 104 of the securing portion 55 of the coupling opening 53 and a bottom portion 106 of the radial slot 100 of the pawl 21 (see FIG. 7). In the freewheeling position of the transfer lever 61 (FIG. 8) the pawl 21 is freely moveable relative to coupling lever 45 and transfer lever 61 by virtue of the coupling pin 59 being freely or floatingly guided by the freewheeling portion 57 of the coupling opening 53 and the transfer opening 71. In the securing position the coupling pin 59 is hold in the securing portion 55 of the coupling opening 53, more precisely in the bottom portion 104 thereof, thereby securely coupling the pawl 21 to the coupling lever 45 and thus to the release actuator 41.

The catch 9 comprises a protrusion 75 which is a arranged such that, when the catch 9 rotates in direction 43 from its locked to its unlocked position (FIG. 8), the protrusion abuts against and moves along a cam surface formed by an edge 77 of the transfer lever 61, thereby rotating the transfer lever 61 in direction 70 from its securing position to its freewheeling position, thus transferring the coupling pin 59 from the securing portion 55 of the coupling opening 53 to the freewheeling portion 57 of the coupling opening 53.

In a preferred embodiment, the protrusion 75 of the catch 9 and the edge 77 of the transfer lever 61 are arranged such that the transfer lever 61 has completed transfer of the coupling pin 59 from the securing portion 55 to the freewheeling portion 57 immediately after the detent portion 29 of the catch 9 has passed the retaining portion 27 of the pawl 21 during rotation of the catch 9 from its locked to its unlocked position. This avoids undue engagement of pawl and catch when the catch, starting from the intermediate unlocked state of the locking device, rotates towards its unlocked position.

In another embodiment the catch may comprise several detent portions wherein each of these detent portions are engagable with the retaining portion of the pawl thereby providing different locked positions of the catch. In this case the protrusion of the catch and the edge of the transfer lever preferable are arranged such that the coupling pin is transferred from the securing portion to the freewheeling portion only after all of the detent portions of the catch have passed the retaining portion of the pawl during rotation of the catch from its locked to its unlocked position.

The protrusion 75 can be integral with the catch 9, or it can be a separate element attached to the catch 9.

The pawl 21 is rotatable between a locked position, in which the pawl 21 holds the catch 9 in its locked position, or is ready to hold the catch in its locked position, i.e. when the catch is unlocked, but ready to be locked, and an unlocked position, in which the catch 9 is in its unlocked position or is free to rotate to its unlocked position. In the locked position compared to the unlocked position, the pawl 21 has been rotated in direction 68a and is positioned such that the retaining portion 27 of the pawl 21 engages or is ready to engage the corresponding detent portion 29 of the catch 9 (FIGS. 4-6), depending of whether the catch 9 is in its locked or unlocked position.

The rack 41 (release actuator) is moveable linearly between a locked (FIG. 9, towards the left) and an unlocked position (FIGS. 10 to 13, towards the right.).

The locking device I is in its locked state when the catch 9, the pawl 21 and the rack 41 of the release actuator are in their locked positions. In the locked state the closure panel 3 is locked to the body 7 of the vehicle 5.

The locking device 1 is in an intermediate unlocked state when the pawl 21 and the rack 41 of the release actuator are in their unlocked positions, but the catch 9 is in its locked position, e.g. because of an external force acting on the closure panel and inhibiting a regular opening action.

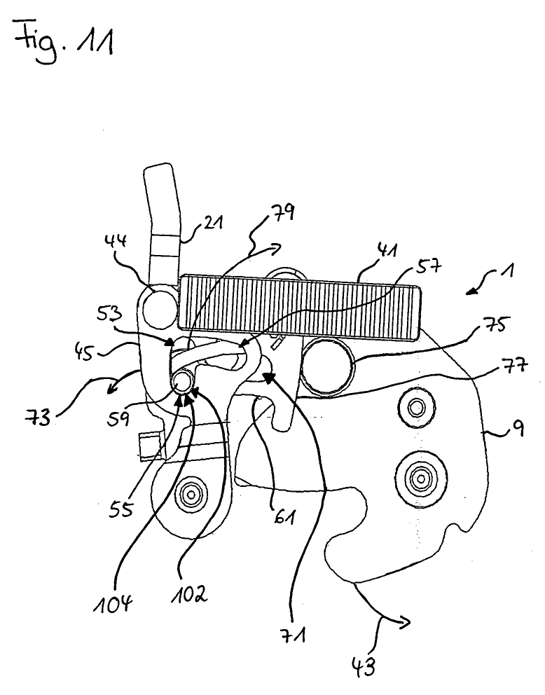

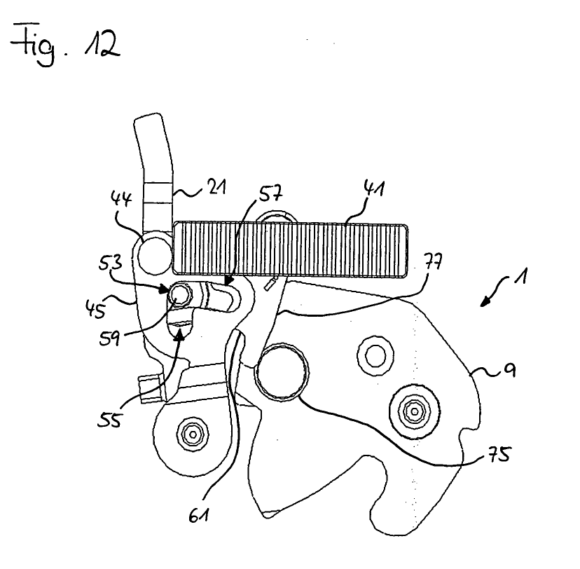

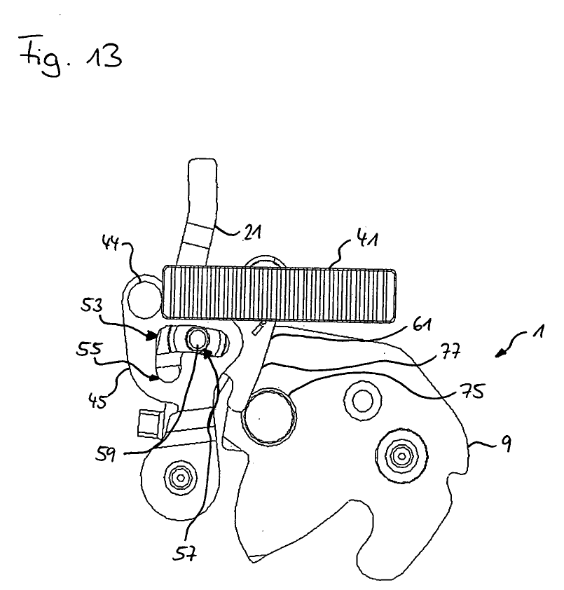

FIGS. 9 to 13 illustrate an unlocking action of the locking device 1. In FIG. 9 the catch 9, the pawl 21 and the rack 41 of the release actuator are shown in their locked positions, thus the locking device 1 is in its locked state. The coupling pin 59 is held in the securing portion 55 of the coupling opening 53 by the transfer lever 61, thereby coupling the pawl 21 to the coupling lever 45 and thus to the rack 41 of the release actuator. In order to unlock the locking device 1 a user activates the release actuator whereby the rack 41 moves from its locked position to its unlocked position towards the left and towards the protrusion 44 of the coupling lever 45, thereby rotating the coupling lever 45 in direction 73. Since the pawl 21 is securely coupled to the coupling lever 45, the pawl 21 rotates along with the coupling lever from its locked position to its unlocked position in direction 73 and disengages the catch 9 (FIG. 10 shows the locking device at the end of the unlocking movement of the rack 41, i.e. at its unlocked position). Due to the rotational force provided by the catch spring 13 the catch 9 now begins to rotate in direction 43 towards its unlocked position. The protrusion 75 of the catch 9 abuts against and moves along the edge 77 (cam surface) of the transfer lever 61 thereby rotating the transfer lever 61 in direction 79 (see FIG. 11) and transferring the coupling pin 59 from the securing portion 55 of the coupling opening 53 to the freewheeling portion 57 of the coupling opening 53 (see FIG. 12). Since the pawl 21 is now freely moveable, pawl spring 31 begins to rotate the pawl 21 back to its locked position (see FIG. 13). In this position the pawl 21 is again ready to engage the catch 9, when the closure panel 3 is closed to the body 7 of the vehicle 5, i.e. when the striker 10 rotates the catch 9 back to its locked position. Therefore, the closure panel 3 can now be locked to the body 7 of the vehicle 5 independently of the position of the rack 41 of the release actuator and the coupling lever 45. If e.g. because of an electrical failure of the release actuator the rack 41 cannot be returned to its locked position, but remains in its unlocked position shown in FIGS. 10 to 13, the closure panel 3 can still be locked to the body 7, because the pawl 21 is in its locked position and ready to engage the catch 9.

Another advantage of the locking device 1 of the present invention is that it provides a release memory function which allows the pawl 21 to move to its locked position only if during a previous unlocking action the catch 9 has moved to its unlocked position. If the spring force of the catch spring 13 is not large enough to rotate the catch 9 after a user has activated the release actuator, e.g. because an inside or outside load prevents the closure panel 3 from opening, the coupling pin 59 remains in the securing portion 55 of the coupling opening 53, and thus the pawl 21 remains securely coupled to the coupling lever 45 and the rack 41, i.e. the pawl 21 and the rack 41 remain in their unlocked positions (intermediate unlocked state of the locking device). In this state the pawl 21 remains disengaged from the catch 9 so that a user can manually open the decklid 9.

In the embodiment described above the springs 13, 31, 47, 65 are torsion springs. Alternatively, pressure springs or tension springs can be used.

The catch 9, the pawl 21, the coupling lever 45, the transfer lever 61 and the rack 41 are mounted in a housing 81 (schematically shown in FIG. 8). The housing 81 can be attached to or form a base frame 11.

The pawl 21 comprises an extension 83 which protrudes outside the housing 81. The extension 83 can be grasped manually to disengage the pawl 21 from the catch 9 in case of a failure of an electric component of the locking device 1.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A locking device for locking a closure panel, comprising:
a catch rotatable between a locked position and an unlocked position;
a pawl rotatable between a locked position and an unlocked position, the pawl including a retaining portion engagable with a corresponding detent portion of the catch;
a release actuator movable between a locked position and an unlocked position for moving the pawl; and
coupling means for selectively coupling the release actuator to or uncoupling the release actuator from the pawl,
the locking device being in a locked state when the catch, the pawl, and the release actuator are in their locked positions, and
the locking device being in an intermediate unlocked state when the catch is in its locked position and the pawl and the release actuator are in their unlocked positions.

2. The locking device of claim 1, wherein the catch is spring biased toward its unlocked position.

3. The locking device of claim 1, wherein the pawl is spring biased toward its locked position.

4. The locking device of claim 1, wherein the coupling means couples the release actuator to the pawl when the locking device is in the locked or intermediate unlocked state and uncouples the release actuator from the pawl when, starting from the intermediate locked state, the catch moves to its unlocked position, whereby the pawl is released to its locked position and the locking device is ready for locking.

5. The locking device of claim 1, wherein the coupling means comprises a rotatable coupling lever coupled to the release actuator.

6. The locking device of claim 5, wherein the coupling lever and the prawl are rotatable around a common rotational axis.

7. The locking device of claim 5, further comprising a coupling lever spring, connected to the coupling lever for providing a spring force biasing the coupling lever towards the release actuator.

8. The locking device of claim 7, wherein the coupling lever spring comprises a torsion spring.

9. The locking device of claim 5, wherein the release actuator comprises a linearly movable release element having an end portion that abuts against a protrusion of the coupling lever for rotating the coupling lever.

10. The locking device of claim 9, wherein the release element is a linearly movable rack.

11. The locking device of claim 6, wherein the coupling lever comprises a coupling opening having a slot-like securing portion defined by side edges substantially extending in radial directions with regard to the rotational axis and a slot-like freewheeling portion defined by side edges substantially extending in a circumferential direction with regard to the rotational axis;
the securing portion extending between first and second radial positions, and
the freewheeling portion extending between first and second circumferential positions.

12. The locking device of claim 11, wherein the pawl comprises a slot extending in a radial direction with regard to the common rotational axis, the slot extending between said first and second radial positions.

13. The locking device of claim 12, further comprising a coupling pin disposed in the slot and in the coupling opening of the coupling lever,
wherein the pawl is securely coupled to the coupling lever when the coupling pin is positioned in the securing portion of the coupling opening, and
wherein the pawl is freely movable within the first and second circumferential positions relative to the coupling lever when the coupling pin is positioned in the freewheeling portion of the coupling opening.

14. The locking device of claim 13, wherein the coupling means further comprises a rotatable transfer lever for transferring the coupling pin form the securing portion of the coupling opening to the freewheeling portion of the coupling opening and vice versa.

15. The locking device of claim 11, wherein the coupling opening is substantially L-shaped.

16. The locking device of claim 14, wherein the transfer lever comprises an arcuate slot-like transfer opening, the transfer lever being rotatable between a freewheeling position and a securing position,
wherein in the freewheeling position, the transfer opening extends in a circumferential direction with regard to the common rotational axis of the coupling lever and the pawl, and is in register with the freewheeling portion of the coupling opening such that the coupling pin is freely movable within the freewheeling portion and the transfer opening, and
wherein in the securing position, an end portion of the transfer opening is positioned at a radial position corresponding to a bottom portion of the securing portion of the coupling opening and a bottom portion of the slot of the pawl such that the coupling pin is held in the bottom portions of the securing portion and of the slot, respectively.

17. The locking device of claim 16, wherein the catch comprises a protrusion arranged such that when the catch rotates from its unlocked position to its locked position, the protrusion abuts against and moves along an edge of the transfer lever, thereby rotating the transfer lever from its securing position to its freewheeling position and transferring the coupling pin of the pawl from the bottom portion of the securing portion of the coupling opening to the freewheeling portion thereof.

18. The locking device of claim 14, wherein the transfer lever is positioned between the pawl and the coupling lever.

19. The locking device of claim 14, further comprising a transfer lever spring for providing a spring force biasing the transfer lever so as to move the coupling pin into the securing portion of the coupling opening of the coupling lever.

20. The locking device of claim 20, wherein the transfer lever spring comprises a torsion spring.

21. The locking device of claim 1, wherein the catch, the prawl, and the coupling means are mounted in a housing, the prawl comprising an extension that protrudes outside the housing to allow for manually rotating the pawl to its unlocked position.

22. The locking device of claim 1, wherein the coupling means is arranged such that during rotation of the catch from its locked position to its unlocked position, the pawl remains coupled to the release actuator as long as the detent portion of the catch has not passed the retaining portion of the pawl, and is uncoupled from the release actuator after the detent portion of the catch has passed the retaining portion of the pawl.

23. The locking device of claim 1, wherein the catch comprises a plurality of successive detent portions each successive detent potion corresponding to the retaining portion of the pawl to hold the catch in successive locked positions, and
wherein the coupling means is arranged such that during rotation of the catch from one of its successive locked positions to its unlocked position, the pawl remains securely coupled to the release actuator as long as not all of the successive detent portions have passed the retaining portion of the pawl, and the pawl is uncoupled from the release actuator after all of the detent portions of the catch have passed the retaining portion of the pawl.

24. The locking device of claim 1, wherein the closure panel comprises at least one of a decklid, a door, a rear flip glass, and a hood.

25. A vehicle comprising a closure panel pivoted to a body of the vehicle for closing an opening of the body comprising the locking device of claim 1 attached to one of the closure panel and the body of the vehicle and a locking striker attached to the other of the closure panel and the body of the vehicle, wherein the catch of the locking device is in engagement with the locking striker when the locking device is in its locked position, and wherein the catch is in disengagement with the locking striker when the locking device is in its unlocked position.

26. A locking device for locking a closure panel, comprising:
a catch rotatable between a locked position, in which the closure panel is locked, and an unlocked position, in which the closure panel is unlocked, the catch being spring biased towards its unlocked position;
a pawl rotatable between a locked position, in which the pawl holds or is ready to hold the catch in its locked position, and an unlocked position, in which the catch is free to rotate to its unlocked position, the pawl including a retaining portion engagable with a corresponding detent portion of the catch and the pawl further being spring biased towards its locked position;
a release actuator movable between a locked position and an unlocked position for moving the pawl; and
coupling means for selectively coupling the release actuator to or uncoupling the release actuator from the pawl,
the locking device being in a locked state when the catch, the pawl, and the release actuator are in their locked positions,
the locking device being in an intermediate unlocked state when the catch is in its locked position and the pawl and the release actuator are in their unlocked positions, and
the coupling means coupling the release actuator to the pawl when the locking device is in the locked or intermediate unlocked state and uncouples the release actuator from the pawl when, starting from the intermediate locked state, the catch moves to its unlocked position, whereby the pawl is released to its locked position and the locking device is ready for locking.
